(19) United States
(12) Patent Application Publication
(10) Pub. No.: US 2013/0002393 A1
(43) Pub. Date: Jan. 3, 2013

(54) FUSE LINK STATUS INDICATOR FOR A LOW-VOLTAGE HIGH-POWER FUSE

(76) Inventors: Nikola Kopcic, Zagreb (HR); Davor Kopcic, Zagreb (HR)

(21) Appl. No.: 13/583,651

(22) PCT Filed: Mar. 16, 2011
(86) PCT No.: PCT/HR2011/000008

§ 371 Date: Sep. 10, 2012

(30) Foreign Application Priority Data
Mar. 18, 2010 (HR) P20100161A

(51) Int. Cl. H01H 85/30

(52) U.S. Cl. 337/227

(57) ABSTRACT

Fuse link status indicator for a low-voltage high-power fuse, according to the invention, relates to the design of low-voltage high-power fuses, or, to be more specific, to the solution of its integral assembly which gives a visual indication of the state of the fuse link within the cartridge of the fuse, that is, reliably concluding whether the fuse link is blown or not. The substance of the invention contains the fact that the force F_{P} for displacing (3.9) the indicator lamella (2.1) along the channel (3.8) for the indicator lamella from the start, which reflects the state of the blowing of the fuse link (3.1) of the fuse not having occurred, to the final position which the indicator lamella (2.1) occupies in the state when the blowing of the fuse link (3.1) of the fuse has occurred, is produced by the compressive spring (4.1) located in the lower part of the channel (3.8) of the indicator lamella, in such a way that the compressive spring at one of its ends is leaning against the lower cover (1.2d) of the fuse housing, and the other end is pressing against the lower front edge (3.10) of the indicator lamella and acts to it with the required force attempting to push it from the starting to the final position, whereat the indicator lamella (2.1) is shaped so that at the appropriate place through the entirety its thickness dL (5.1) a breach (4.2) is made, which is, relatively to the shape, size and location of the indicator opening (1.6) in the frontal part of the front wall (3.6) of the housing/mantle (1.1) of the fuse, of such shape and size, and so located at the indicator lamella (2.1), that in the final position of the indicator lamella (2.1) such coincidence is achieved of the breach (4.2) and the indicator opening (1.6) due to which through the indicator opening (1.6) in the fuse mantle wall, not a single part of the indicator lamella surface be visible (2.1) nor any part of the compressive spring (4.1). The design of the indicator assembly according to the invention concerned offers the possibility of the indicator lamella (2.1) being made of thermoplastic material of any desired colour using injection technology. As to the state of the fuse link (3.1) of the fuse, it may also be additionally concluded, based on the fact that at the final position of the indicator lamella (2.1), which may be realized by injecting the thermoplastic material of a desired colour, that its part that is the surface (6.1) next to upper front edge (3.11), becomes visible, so that in this position, the surface (6.1) protrudes above the upper cover (1.2g) in the fuse mantel wall, additionally showing/indicating that the fuse link (3.1) of the fuse is blown. The indication and reporting on the state of the fuse link in the cartridge of a fuse is also achieved through an additional feature of the indicator lamella (2.1) which acts, as a moveable part, on the microswitch (11) which is located on and fixed to the upper cover (1.2g) of the fuse housing in such a manner that the indicator lamella (2.1) moving from the starting to its final position shifts the acting lever (11.3) of the microswitch (11) from the free to the compressed position, which is followed by the switching of the selected contact circuit, while in its starting position the indicator lamella (2.1), acting lever (11.3) of the microswitch (11) naturally occupies a free position.

### DESCRIPTION OF THE INVENTION

1. Technical Field

The invention concerned relates to the solution of indicator, being an integral element of a low-voltage high-power fuse cartridge, giving the visual indication of the fuse link status, respectively a reliably conclusion on weather the fuse link is blown or this has not happened. Technical area the invention concerned relates is designated as H01H85/30 according to International Patent Classification.

2. Technical Problem

Technical problem to be solved using the invention concerned emerges from the need for reliable and prompt availability of the information weather was, due to malfunction, overload or short circuit, triggered a particular low-voltage high-power fuse, which is otherwise built in public power network for the purpose of user protection.

It is generally known that the low-voltage high-power fuses are built in low-voltage power network into branches which are powering, from an electric energy source through the power network, one or more consumers, and that this fuses function is to ensure protection of those consumers being powered from the network. In case of malfunction, overload or short circuit on one or more consumers protected by a certain fuse in a certain branch, follows triggering of the fuses built in the branch, essentially blowing the fuse link in the cartridge of respective fuse, which has the effect of physical breaking the electric connection with power source, respectively disconnection in supplying the electric power from the source to the consumers being protected.

By the fuse action of melting the fuse link in the fuse cartridge, actually causing break of the connection between the consumer and the electric power source, achieved is the prevention of larger breakdowns and damages, but in the same time it means that the respective consumers are out of electric power what dictates the need of undertaking all the available measures to shorten the duration of this condition as much as possible.

In this context a particular importance has the fact that, after melting of the fuse link within the fuse action, this fuse cartridge becomes unusable and that, after the malfunction cause is identified, and failure is repaired, respective fuse cartridge with melted fuse link has to be replaced with appropriate new one. Therefore, understandable are the needs and interests to reliably detect, as soon as possible, preferably instantly, the triggering of a particular fuse, to be able to approach to the detecting and amending the failure cause and then to replace the fuse cartridge of the blown fuse what ensures the possibility to reestablish electric powering of the respective consumers being protected by the blown fuse.

This circumstance has the crucial impact on finding the technical problem solution, what refers the need for the information on weather the interruption in powering of certain consumers in power network is caused by triggering a particular fuse to be derived from the insight into the state of fuse link of the respective fuse cartridge, that is, weather the fuse link has been melted or it has not happened. Thus, blown fuse link of the fuse indicates that the fuse has been triggered, while on the other side the fuse link not being blown is the reliable clue that the fuse has not been triggered.

In obtaining the desired insight into fuse link state, respectively reliable conclusion on weather the fuse triggering has happened through the melting of the fuse link or it has not happened, the problem emerges caused by the fact that the fuse link is located inside the fuse cartridge housing, its mantle walls made of nontransparent material, of steatite as a rule, therefore the fuse link located inside the fuse cartridge is completely invisible from outside.

Therefore, determining weather the fuse link of the fuse cartridge is blown or it has not happened, is not possible through the direct observation of built in fuse cartridges and remains to achieve this in an indirect way, using additional assembly of elements properly incorporated into the fuse cartridge, known under the term of fuse indicator.

Solving the technical problem consists, therefore, of inventing an appropriate additional assembly of elements, which comprise the indicator, adequately incorporated into the individual low-voltage high-power fuse cartridge.

The construction of this additional assembly has to enable the insight, even from a certain safety distance, respectively the reliably and prompt concluding on weather the melting of the fuse link in the fuse as a consequence of fuse activation because of current overload and/or short circuit in the network protected by this fuse has happened or has not happened.

Solving this additional assembly according to the invention under the name of status indicator of fuse link in the cartridge fuse, the solution of the technical problem is obtained.

3. State of the Art

As it is known, to obtain the desired characteristic of fuse activation, fuse link (3.1) of the fuse is made of adequately shaped, as a rule, copper strip of appropriate thickness and formed in adequate way, then placed in silica sand (3.2) of the fuse. Fuse housing covers (1.2) through which the connecting elements are passing (1.4), are fixed with mounting screws (1.3) to the housing mantle (1.1) of the fuse link, whereby a closed space is created in which, free of environmental influences, acts the fuse link (3.1) of the fuse, surrounded by silica sand. The fuse housing mantle (1.1) may be designed in desired cross sections, so known are rectangular, square and round ones, but also the other cross section forms.

Practically all solutions to the technical problem concerned which are covered by the actual state of the art are realized as a separate assemblies incorporated into the classically designed cartridges for low-voltage high-power fuses. Obligatory integral part of these separate assemblies is indicating melting wire (3.3) which is spanned between the fuse housing covers (1.2), upper (1.2g) and lower (1.2d) one, to which it is mechanically and electrically reliably fixed by connections (3.4) and (4.3). The wire is in its tensed state electrically connected in parallel to the fuse link (3.1) of the fuse, so that at outburst of current overload or short circuit in the power network protected by the fuse concerned, melting blows fuse link (3.1) of the fuse and practically in the same moment also blows the indicating melting wire (3.3) due to its essentially smaller cross section then fuse link (3.1) of the fuse.

Besides, in all of these solutions the indicating melting wire (3.3) is incorporated into the fuse cartridge in such manner that in tensed state it is laid in front of upper fore edge (3.11) of the indicator lamella to reliably prevent the displacement and motion of the indicator lamella in spite of the displacement force F_{P} (3.9) impact.

Hence, the indicating melting wire (3.3), incorporated in before described way, is used as the means to prevent the displacement and motion of the indicator lamella (2.1) inside the indicator lamella channel (3.8) in spite of the displacement force F_{P} (3.9) action, so that only after blowing the indicating melting wire (3.3) which occurs practically simultaneously with blowing fuse link (3.1) of the fuse itself, this physical obstacle disappears and motion of the indicator lamella is enabled inside the indicator lamella channel (3.8), from one (start) to the other, utter (final) position.

The possibility of moving the indicator lamella (2.1) inside its channel (3.8) enables certain displacement force F_{P} (3.9), which permanently acts upon the indicator lamella (2.1) while it is in its start position, attempting to move it to the final position what, however, prevents the indicating melting wire (3.3) in before described way, all the time till its moment of blowing.

The indicator lamella (2.1) is otherwise located inside the indicator lamella channel (3.8), whose cross cut is usually rectangle shaped and axially made in the front wall (1.5) on part or on entire fuse housing height. The indicator lamella (2.1) inside the indicator lamella channel (3.8) is movable between the two utter positions, start and final one.

According to the method of producing the force F_{P} (3.9) to move indicator lamella from the start to the final position, the solutions of the indicator assembly are distinguished.

Within all solutions according to the known state of art one of the two utter positions of the indicator lamella (2.1) reflects the state when blowing of the fuse link (3.1) in the fuse has not happened, usually it is start position, in which position through the indicator opening (1.6) in frontal part of fuse mantle front wall (3.6) the appropriate part of the indicator lamella surface is visible, showing certain marking (3.5), namely color, as a rule red, which is painted on the indicator lamella as the marking (3.5). Otherwise, the indicator opening (1.6) in frontal part of fuse mantle front wall (3.6) is usually roundly shaped.

Congruently to that, other utter, final position occupies the indicator lamella (2.1) in state when the fuse was activated blowing the fuse link (3.1) of the fuse and hereby the indicator melting wire (3.3) what under the action of displacement force F_{P} (3.9) on the indicator lamella results in its movement along the indicator lamella channel (3.8) from the start to the final position.

Within a dominant number of solutions according to the known state of the art, in this final position through the indicator opening (1.6) in fuse mantle wall, no marking (3.5) is seen on the indicator lamella (2.1), nor any part of the indicator lamella (2.1), because in this position lower frontal edge (3.10) of the indicator lamella (2.1) occupies the position above the upper edge (3.12) of the indicator opening in the frontal part of fuse mantle front wall (3.6) in the fuse housing (1.5).

The state of the art in domain of technical solutions for indicator assembly includes a few groups of indicator assembly designs which are giving the possibility to conclude if the fuse link of the fuse was blown, respectively if the fuse link in activating the fuse by current overload or short circuit was blown or this has not happened.

Basically, it is common to all solutions encompassed in the known state of the art (EP 1 560 245, EP 1 612 826, EP 1 513 180, EP 1 345 247, DE 100 66 075, DE 100 05 145, WO 00/11698, WO 99/40 599, DE 197 44 535, DE 197 23 540, DE 196 44 901, WO 98/07 172, WO 98/07 170, DE 42 36 212, EP 0 420 351, EP 0 201 714, DE 32 03 211, EP 0 049 374, EP 0 044 997, FR 1 465 397 and DE 10 34 751) that the conclusion on the fuse link (3.1) of the fuse condition is made based on the two possible utter positions of the indicator lamella (2.1), starting position which it occupies in the state before blowing the fuse link (3.1) of the fuse, or the final position which it occupies in the state when blowing the fuse link (3.1) of the fuse already occurred.

As well, it is common to all the solutions presented in abovementioned patent documents that on one of the two possible utter positions of the indicator lamella (2.1), inside the indicator lamella channel (3.8) of the indicator lamella, conclusion is made based on color of indicator lamella (2.1) which is, in on if its utter positions, visible through the indicator opening (1.6) in the frontal part of front wall (3.6) in the fuse housing.

This is achieved so that appropriate part of the indicator lamella (2.1) surface is painted in a certain color, as a rule red, forming the marking (3.5) on the indicator lamella (2.1) which is in starting position of the indicator lamella (1.2) visible through the indicator opening (1.6) in the frontal part of front wall (3.6) in the fuse housing, thereby indicating status that the melting of fuse link (3.1) in the fuse has not happened.

Majority of the solutions are designed so that in status when blowing the fuse link (3.1) has occurred and thereby also the indicating melting wire (3.3), the indicator lamella (2.1) under the action of certain force for displacing the indicator lamella moves to its utter position in which lower frontal edge (3.10) of the indicator lamella (2.1) occupies the position above the upper edge (3.12) of the indicator opening in the frontal part of fuse mantle front wall (3.6) in the fuse housing (1.5), and therefore through the indicator opening (1.6) in the frontal part of fuse mantle front wall (3.6) no marking (3.5) can be seen, respectively color painted on the appropriate part of the surface, nor even any part of the indicator lamella (2.1).

However, for a difference to the abovementioned solutions, also are existing solutions (e.g. DE 197 23 540) including the design according to which the indicator lamella (2.1) has such length that, due to the extension of the indicator lamella (2.1) also in the utter position its lower frontal edge (3.10) finds below the lower edge (3.13) of the indicator opening (1.6) in the fuse mantle front wall and on appropriately extended indicator lamella (2.1) two markings are dyed; hence, along with the abovementioned one (3.5) the additional (3.5d). This is achieved by dying two as a rule different, colors on two separate adequately located areas of the indicator lamella (2.1) so that through the indicator opening (1.6) in the fuse mantle wall the visibility is enabled to one of the markings: marking (3.5) or additional marking (3.5d) on the indicator lamella (2.1), depending on the position (start or final) of the indicator lamella (2.1), each of the colors referencing one of the states not-blown/blown of the fuse link (3.1) in the fuse.

In this way based on the different colors of indicator lamella (2.1) areas, dyed as marking (3.5) and marking (3.5d) visible through the indicator opening (1.6) in the fuse mantle front wall of the fuse, the conclusion can be made on the states not-blown/blown of the fuse link (3.1) in the fuse.

Besides the concluding based on the color of the marking (3.5) and possibly of the marking (3.5d), respectively the appropriate color dyed on adequate areas of the indicator lamella (2.1) which is visible through the indicator opening (1.6) in the wall of fuse mantle, considerable number of solutions (EP 1 560 245, EP 1 612 826, EP 1 345 247, DE 198 04 777, DE 197 44 535) ensure the possibility to make additional conclusions on the state not-blown/blown of the fuse link (3.1) in the cartridge based on the fact that in the utter position of the indicator lamella (2.1), a part of its surface (6.1) next to the upper frontal edge (3.11) becomes visible because this part of the surface in the utter position protrudes above the upper cover (1.2g) of the fuse housing. This part of the indicator lamella surface (6.1), visible in its utter position is dyed in proper, as a rule red color.

Noticeability of this part of the surface (6.1) of the indicator lamella (2.1) in the utter position of the indicator lamella (2.1), combined with what is in the same time visible through indicator opening (1.6) in the fuse mantle wall (without the visibility of any part of indicator lamella (2.1) or visibility of the marking 3.5d), is taken as a double indication for the state of fuse link being blown.

It is self understandable that in previously described solutions, in the starting position of the indicator lamella (2.1), not a single surface part (6.1) next to the upper frontal edge (3.11) is visible above the upper cover (1.2g) of the fuse housing because then the entire indicator lamella (2.1) is inside the indicator lamella channel (3.8); this, along with what is visible through the indicator opening (1.6) in the frontal part of the fuse mantle wall (marked 3.5), additionally indicates that the fuse link (3.1) of the fuse is not blown.

The differences between the technical solutions encompassed by the state of the art are emerging above all in its methods of generating the force F_{P} for displacing (3.9) the indicator lamella (2.1) along the indicator lamella channel (3.8) between the two utter, starting and final positions.

Thus, according to certain patent documents (e.g.: EP 1 560 245, EP 1 345 247, and DE 10 34 751), the force Fₚ for displacing (3.9) of indicator lamella (2.1) along the indicator lamella channel (3.8) from its starting position, which reflects the status when blowing the fuse link (3.1) of the fuse has not happened, and reaching the final position which the indicator lamella (2.1) occupies in the status when blowing the fuse link (3.1) of the fuse has occurred, produces a compressive spring located in somewhat widened upper part of the indicator lamella channel (3.8) next to the upper front edge (3.11) of the indicator lamella (2.1).

To realize such placement of the compressive spring, a part of indicator lamella (2.1) has to be pulled through the compressive spring, and therefore the indicator lamella (2.1) at a certain part has to be appropriately narrowed, to enable its unobstructed motion under the action of the displacement force F_{P} (3.9) produced by the compressive string.

On the other side, at a considerable number of the technical solutions encompassed by the state of the art according to the patent documents (e.g.: EP 1 612 826, EP 1 513 180, DE 100 66 075, DE 100 05 145, WO 99/40 599, DE 197 44 535, DE 197 23 540, DE 42 36 212, EP 0 044 997, FR 1 465 397) the force F_{P} for displacing (3.9) of indicator lamella (2.1) in the indicator lamella channel (3.8) from its starting position, produces the indicator lamella (2.1) itself, due to the fact that it is made of springy metal sheet and formed so that one of its parts has, in the starting position of the indicator lamella (2.1), springy property which enables it to produce the necessary force F_{P} for displacing (3.9) of indicator lamella (2.1). It happens so that blowing the indicating melting wire (3.3) triggers the properly shaped springy part of the indicator lamella which is as a rule placed above the upper cover (1.2) of the fuse housing, and due to it the force F_{P} for displacing (3.9) of indicator lamella (2.1) acts undisturbed, what enables the motion of the indicator lamella (2.1) from the starting to the final position along the channel (3.8).

The same concept, but somewhat different in details of the indicator lamella (2.1) design, is applied in the solutions according to the other patent documents, e.g.: DE 32 03 211, EP 0 201 714 and EP 1 213 404.

It is the fact that the amount of force F_{P} for displacing (3.9) of the indicator lamella (2.1) in the indicator lamella channel (3.8) from its initial position, being produced only by the springy property of the indicator lamella (2.1) introduces the crucial limitation, practically excluding the solutions according to which it would be possible to use movement of the indicator lamella (2.1) to its final position so that the indicator lamella (2.1) applying the available force also switches a micro-switch enabling the possibility of additional remote electric signalization of the indicator lamella (2.1) position, and such solutions are not met within the known state of the art.

It is essential to emphasize that not a one solution according to the known state of the art encompassed by the aforementioned patent documents, does not include the indicator assembly at which the force F_{P} for displacing (3.9) of the indicator lamella (2.1) between the two utter, starting and final position in the indicator lamella channel (3.8) is produced by a compressive spring located in the lower part of the indicator lamella channel (3.8), so that the compressive spring, supported at one of its ends by the lower cover (1.2d) of the fuse housing, presses with its another end the lower front edge (3.10) of the indicator lamella (2.2).

### 4. ESSENCE OF THE INVENTION

The essence of the invention concerned is contained in the fact that the force F_{P} for displacing (3.9) of the indicator lamella (2.1) between the starting and final position is produced by a compressive spring (4.1) located in the lower part of the indicator lamella (2.1) channel (3.8), so that the compressive spring (4.1), supported at one of its ends by the lower cover (1.2d) of the fuse housing, presses with its another end, with the force F_{P} for displacing (3.9) the lower front edge (3.10) of the indicator lamella (2.1), thus acting on it with a necessary force, attempting to move it from the initial to the final position, whereat the indicator lamella (2.1) is designed so that at proper place through a whole its thickness d_{L} (5.1) a breach (4.2) is made which, regarding the shape, size and location of the indicator opening (1.6) in the frontal part of fuse mantle front wall (3.6) of the fuse housing (1.1), has such shape, size and location on the indicator lamella (2.1) to obtain such coverage of the breach (4.2) and the indicator opening (1.6) that through the indicator opening (1.6) in the fuse mantle wall not a one part of the indicator lamella (2.1) is visible, and therefore any colors being the colors of the indicator lamella (2.1) itself or colors dyed on it are not visible.

Besides, although the indicator lamella (2.1) has length h_{L} and is shaped so that its lower frontal edge (3.10), which supports one end of the compressive spring (4.1), always, means in the starting and in the final position, founds itself under the lower edge (3.13) of the indicator opening (1.6) in the frontal part of fuse mantle front wall (3.6) of the fuse housing (1.1); still, in the final position of the indicator lamella (2.1) through the indicator opening (1.6) in the fuse mantle wall the visibility is impossible to any part of the compressive spring (4.1) what is achieved due to the fact that the indicator lamella (2.1) is designed so that it has at proper place through a whole its thickness d_{L} (5.1) breach (4.2) made as specified before.

As in previously described known state of the art, in the solution according to the invention concerned, moving of the indicator lamella (2.1) from the starting to the final position along the indicator lamella channel (3.8) is prevented by the indicating melting wire (3.3) which is firmly connected in lower joint (3.4) to the lower (1.2d) and in upper joint (3.14) to the upper cover (1.2g) of the fuse housing and electrically connected in parallel to the fuse link (3.1) of the fuse and in tensed state laid above the upper front edge (3.11) of the indicator lamella so that the motion of the indicator lamella (2.1) from the starting to the final position is not possible until occurs blowing of the indicating melting wire (3.3), what happens simultaneously with the blowing of the fuse link (3.1) of the fuse due to the fact that indicating melting wire has essentially smaller cross section than the fuse link (3.1) of the fuse.

Prevention of the possibility the indicator lamella (2.1) to be in its utter position completely thrown out from the indicator lamella channel (3.8) is implemented using a displacement limiter (4.3) of the indicator lamella (2.1) what is realized in the manner that dimensions of the indicator lamella (2.1) in appropriate sector hp (5.5) next to its upper front edge (3.11) are insignificantly reduced, respectively in this sector the indicator lamella (2.1) is made with reduced width b_{P} (5.3) and reduced thickness d_{P} (5.4), so that these reduced dimensions are sufficiently smaller than the dimensions of the opening in the cover (1.7) of the fuse housing to enable free passing only to a part of the indicator lamella (2.1) with the reduced dimensions b_{P} (5.3) and d_{P} (5.4).

In the solution according to the invention concerned, when blowing of the indicating melting wire (3.3) occurs, what happens simultaneously with the blowing of the fuse link (3.1) of the fuse, and so disappears the obstacle to the indicator lamella (2.1) movement along the channel (3.8), compressed compressive spring (4.1), located in the lower part of the channel (3.8) of the indicator lamella (2.1), acting on the lower front edge (3.10) of the indicator lamella (2.1) with the force F_{P} for displacing (3.9) of the indicator lamella, produces a displacement of the indicator lamella along the channel (3.8) from the starting to the final position, in which position lower front edge (3.10) of the indicator lamella (2.1) occupies the position under the lower edge (3.13) of the indicator opening (1.6) in the frontal part (3.6) of fuse housing/mantel wall (1.1) of the fuse, whereby is achieved that through the indicator opening (1.6) in the fuse mantle wall the lower front edge (3.10) of the indicator lamella (2.1) is not visible, nor is visible any other part of the compressive spring (4.1).

The technical solution according to the invention, achieving that in the final position of the indicator lamella (2.1), through the indicator opening (1.6) in the fuse mantel wall not only a single part of the compressive spring (4.1) is visible, but also not a single part of the indicator lamella (2.1), although the lower front edge (3.10) of the indicator lamella (2.1) takes the position below the lower edge (3.13) of the indicator opening (1.6), represents a further crucial component of the invention concerned, which consists of the fact that the indicator lamella (2.1) is of such length h_{L} and shaped so that in a proper place through a whole its thickness d_{L} (5.1) a breach (4.2) is made which, regarding the shape, size and location of the indicator opening (1.6) has such shape, size and on the indicator lamella (2.1) has such location that in final position of the indicator lamella (2.1) through the indicator opening (1.6) not a single part of the indicator lamella surface (2.1) is visible, and therefore any colors being the colors of the indicator lamella (2.1) itself or colors dyed on it are not visible, what is otherwise taken as the indication that the fuse link (3.1) of the fuse is blown.

Implementing the indicator lamella (2.1) according to the invention it is achieved that in the final position of the indicator lamella (2.1) through the indicator opening in the mantle wall is not visible not a single part of the indicator lamella (2.1) surface, so not even the part near to its lower front edge (3.10), what means that no color is visible, nor any color being the color of the indicator lamella (2.1) itself, or a color dyed to it. Naturally that in this final position of the indicator lamella (2.1) not a single part of the compressive spring (4.1) is visible. This solution according to the invention gives the same result as do the common and predominant alternative solutions known according to the state of the art, at which also, in the final position of the indicator lamella (2.1) through the indicator opening (1.6) in the fuse mantel wall, can not be seen any part of the indicator lamella (2.1) and therefore nor any marking on it in any color, what represents the indication that the fuse link (3.1) of the fuse is blown.

It is essential to emphasize that the breach (4.2) through the whole thickness d_{L} (5.1) of the indicator lamella (2.1), which in principle may have arbitrary shape and size, although for it, as well as for indicator opening (1.6), round shape is the most acceptable, has to be, related to its location, shape and size of the indicator opening (1.6) of such shape and have such dimensions and be so located on the indicator lamella (2.1) that in the final position of the indicator lamella (2.1) into which it is being shifted through the action of the displacement force F_{P} (3.9) produced by the compressive spring (4.1) located in the described way in the channel (3.8) it is obtained such a concurrence of the breach (4.2) and the indicator opening (1.6) that through the indicator opening (1.6) in the fuse mantel wall it is not possible to see not a single part of the indicator lamella (2.1), what stipulates the request on shape and dimensions of adequately located breach (4.2) made through the indicator lamella (2.1) to be sufficiently larger than the indicator opening (1.6) in fuse mantel wall.

In this way achieved is the result identical to one which some solutions according to the known state of the art are giving in the state when indicator lamella occupies the final position in which at those solutions according to the known state of the art the lower front edge (3.10) of the indicator lamella (2.1) is above the upper edge (3.12) of the indicator opening (1.6) in the fuse mantel wall and due to that in this position it is not possible to see not a single part of the indicator lamella (2.1).

As in the solutions according to the known state of the art, also at the technical solution of the indicator assembly according to the invention, until the occurrence of blowing the indicating melting wire (3.3), the movement of the indicator lamella (2.1) is not possible, and it, in spite of the acting of the displacement force F_{P} (3.9) for the indicator lamella (2.1), produced by compressive spring (4.1) located in the lower part of the channel (3.8) of the indicator lamella (2.1), it remains in its start position, so that through the indicator opening (1.6) in the fuse mantel wall it is possible to see the appropriate part of the indicator lamella (2.1) with the marking (3.5), what should to be used as the indication that the fuse link (3.1) of the fuse is not blown.

As it is previously described in the known state of the art and also according to the solutions of indicator assembly used by majority of the fuse manufacturers in the world, as indication that the fuse link (3.1) of the fuse is not blown, the marking (3.5) is used, and it is in the start position of the indicator lamella (2.1) visible through the indicator opening (1.6) in the fuse mantel wall, which marking is, according to the solutions of indicator assembly used by majority of the fuse manufacturers in the world, made by dying the appropriate color on the related part of the indicator lamella (2.1).

This marking (3.5) at majority of the fuse manufacturers in the world is realized in such shape and size and it is located on the indicator lamella (2.1) in such way that only this part of the indicator lamella (2.1) surface may be visible through the indicator opening (1.6) when the indicator lamella (2.1) is in its starting position.

According to the known state of the art and also according to the solutions for indicator assembly used by majority of the fuse manufacturers in the world, color of the marking (3.5) is as a rule red, although any other colors are not excluded which could become a widely accepted convention.

According to the technical solution of the invention concerned, the indicator lamella (2.1) may be realized so that it is entirely dyed in the color or made of the material whose color is identical to the marking (3.5) color, and which has to be visible through the indicator opening (1.6) when the indicator lamella (2.1) is in its starting position.

Should we, appreciating the known state of the art as well as prevalent if not already dominant practice to accept red as marking (3.5) color, it means that the entire indicator lamella (2.1) according to the technical solution of the invention concerned should be red colored what may be realized dying the entire indicator lamella (2.1) in red or, what is essentially optimal and represents an important part of the solution of the invention concerned, to be made of material whose color is red, thus simply achieving that through the indicator opening (1.6) red color is seen when the indicator lamella (2.1) is in its start position without the need to dye this color to the indicator lamella (2.1).

Previously described technical solution according to the invention, opens the possibility of a realization which enables, as well as at the solutions according to the known state of the art, the additional concluding on the status of the fuse link (3.1) of the fuse based on the fact that in the final position of the indicator lamella (2.1), a part of it as the surface (6.1) next to the upper front edge (3.11) protrudes above the upper cover (1.2g) of the fuse housing, becoming visible in this way.

However, because of the fact that the entire indicator lamella (2.1) is in one, red color, being it entirely dyed in red or being completely made of the material whose color is red, disregarded may be the need to, for obtaining a better noticeability, perform the procedure of dying in red color the surface part (6.1) next to the upper front edge (3.11), which protrudes above the upper cover (1.2g) of the fuse housing, and even without it the sufficient noticeability of the surface (6.1) as a part of indicator lamella (2.1) in its final position, is obtained and in this way additional indicating of the state when the fuse link of the fuse is blown.

According to the invention concerned, the surface (6.1) is an integral part of the indicator lamella (2.1) which is entirely realized in one color, which is consistently to the solutions according to the known state of the art and present predominant practice, red color, whereby obtaining its visibility and noticeability, what contributes that in the combination with what is in this final position of the indicator lamella (2.1) visible or invisible through the indicator opening (1.6) in the fuse mantel wall, it is an additional indication that the fuse link (3.1) of the fuse is blown.

The illustration of possible shapes for the surface (6.1), visible part of the indicator lamella (2.1) is presented by the picture 8. Until now the most often used shape for the surface (6.1), visible part of the indicator lamella (2.1) is square (8.1), whereat it, according to the invention concerned, represents a part of the integrally realized indicator lamella (2.1), realized in a single, red color, so that the surface may be realized also shaped as an exclamation mark (8.4) or divided into two surfaces dying colorless color as a belt of appropriate width, whereby obtaining spaced square forms (8.3).

The surface (6.1) as the marking shaped as exclamation mark (8.2) at the visible part of the indicator lamella (2.1) may be realized so that this visible part of the indicator lamella (2.1) is cut in exclamation mark shape or so that the square surface (8.1) is covered by invisible color with the exception of exclamation point shaped surface.

The technical solution according to the invention concerned opens the possibility the indicator lamella (2.1) to be realized in plastic material in any color, including red, what gives the possibility of injection technology application for its production, and this by its own decisively cuts the production costs for the indicator lamella (2.1) as an indomitable part of the indicator assembly. It is self understandable that the plastic material for indicator lamella (2.1) production has to feature the temperature stability in the conditions of fuse heating during the normal operation as well as during the overload.

In addition, the magnificent availability of all possible colors of plastic materials and its nuances, inclusive variants which guarantee their particularly emphasized visibility even in poor light conditions, opens the possibility the indicator lamella (2.1) with the breach (4.2) on appropriate location and size and shape to be produced by injecting the appropriate red plastic material, hence just in the color which should be otherwise, according to the known state of the art and applied practice, dyed as the marking (3.5) on the part of the indicator lamella (2.1) surface, and also on the surface part (6.1) next to the upper front edge (3.11) which in the final position of indicator lamella (2.1) becomes visible above the upper cover (1.2g) of the fuse housing.

This opens the possibility to realize the technical solution according to the invention, according to which the indicator lamella (2.1) is entirely realized in one, red color, and omits the need to dye the color as the marking (3.5) and also dye the visible part of the surface (6.1) next to the upper front edge (3.11) which in the final position becomes visible, and this gives the possibility for radical cutting of production costs for the indicator lamella (2.1) and thereby for the entire indicator assembly.

The realization of the indicator lamella (2.1) using plastic material injecting technology in addition to that gives us a possibility to realize its lower front edge (3.10) suitably with tight fitting and firm connection for one or more compressive springs (4.1) of the suitable design.

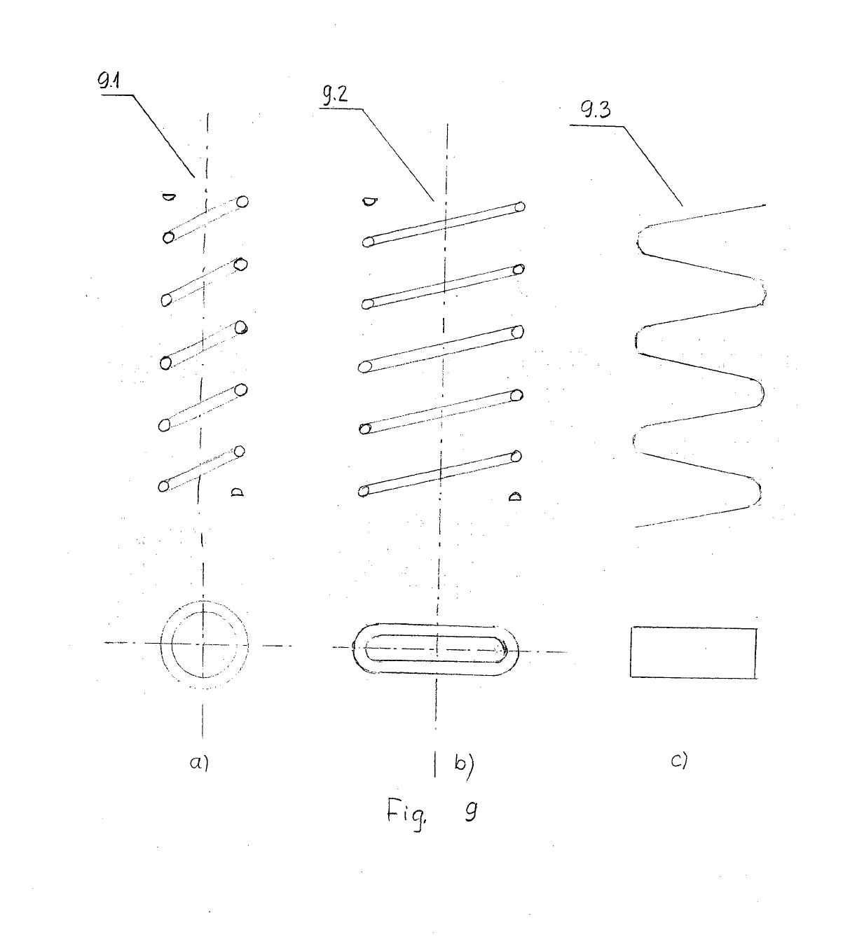

The compressive spring (4.1) may be of any design which is suitable to place it in the channel (3.8) of the indicator lamella, and possible forms are illustrated by FIG. 9, where are presented the possible and the most often used shapes of compressive springs, among them cylindrical (9.1), elliptic (9.2) and laminated (9.3) ones.

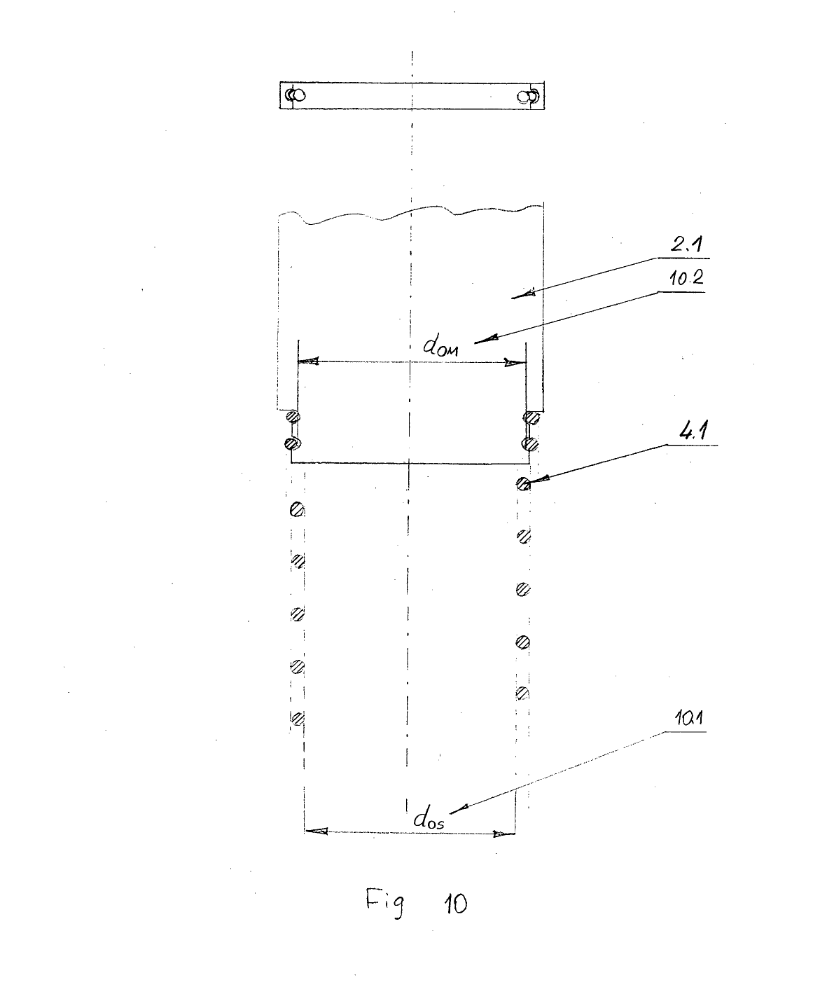

If it goes for the elliptic type of the compressive spring (4.1), its firm connecting to the indicator lamella (2.1) may be realized so that the appropriate part next to lower front edge (3.10) of the indicator lamella (2.1) is dimensioned d_{OM} (10.2), a little larger than the inner dimensions d_{OS} (10.1) of the compressive spring (4.1) in its free stage and with the slots for fitting a few slings of the compressive spring (4.1) as depicted in FIG. 10.

The technical solution according to the invention makes also possible a variant in which the indicator lamella (2.1), although entirely made in an appropriate color, and according to the known state of the art and applicable practice it should be red color, is realized in a variation without the breach (4.2) through the whole its thickness d_{L} (5.1). This solution would normally result in visibility, in the start position of the indicator lamella (2.1) through the indicator opening in the fuse mantle wall, just of the integral indicator lamella (2.1) color or the color being dyed as the marking (3.5).

However, to obtain, in this variant, in the final position of the indicator lamella (2.1) through the indicator opening (1.6) in the fuse mantel wall, not a single color to be seen, what is, according to the known state of the art and predominant practice, the indication that blowing of the fuse link (3.1) of the fuse has occurred, it is necessary, in the solution according to invention concerned, to obtain non-noticeability, respectively invisibility of the part of the indicator lamella (2.1) which should, in its final position otherwise be visible through the indicator opening (1.6). Non-noticeability, respectively invisibility may simple be realized dying the adequate layer of appropriate coating which ensures colorlessness and invisibility under the used type of lighting.

The technical solution according to the invention makes also possible a realization identical to some solutions according to the known state of the art which should consist in that on a proper second location of the indicator lamella (2.1), one more color is applied as the marking (3.5d) in such shape, size and location only at this part of the surface to be visible through the indicator opening (1.6) when the indicator lamella (2.1) is in its final position.

In this way it is obtained that in starting position of the indicator lamella (2.1) through the indicator opening (1.6) is visible one color, and it is the color of integral fuse link or color being applied as the marking (3.5), what according to the known state of the art and predominate practice means to be red color, what indicates that the fuse link (3.1) is not blown. On the other side, in the final position of the indicator lamella (2.1) through the indicator opening (1.6) is visible second color, which should be applied as the marking (3.5d) what would indicate that the fuse link (3.1) is blown.

Realizing of this variant of the technical solution according to the invention obtained is, hence, also a solution adequate to the solutions according to the known state of the art at whom two different colors are applied to two different surfaces of the indicator lamella (2.1) so that each of them is used as a marking (3.5 or 3.5d) in the way that one of them (3.5) with is certain color is visible through the indicator opening (1.6) in the fuse mantle wall in its start position, indicating the state when blowing the fuse link (3.1) of the fuse has not occurred, while the second marking (3.5d) in other color in the final position of the indicator lamella (2.1) indicates the state when blowing the fuse link (3.1) of the fuse has occurred.

For a difference to a certain number of solutions according to the known state of the art in some of previously quoted patent documents, which anticipate the channel (3.8) of the indicator lamella to be realized only in one part of the total height of the housing mantle (1.1) of the fuse, the technical solution according to the invention also includes the possibility to realize the channel (3.8) of the indictor lamella in the entire height of the housing mantle (1.1) of the fuse, what is beneficial to the fuse housing mantle (1.1) manufacturing.

The solution according to the invention concerned, in which the displacement force F_{P} (3.9) on the indicator lamella (2.1) is produced by the compressive spring (4.1), whereby it is possible to obtain major amounts of this force for displacement enabling the indicator lamella (2.1) as a movable part to act on microswitch (11) with a proper acting lever (11.3) with possible two utter, free and pressed positions, and with appropriate connectors (11.1) NO and NC contacts (11.2) of the selected contact circuit, whereat the microswitch (11) is located and fixed on the upper cover (1.2g) of the fuse housing so that the indicator lamella (2.1) moving from its start to its final position shifts the acting lever (11.3) of the microswitch (11) from its free to its pressed position, whereby follows the switching of selected microswitch contact circuit, while in the starting position of the indicator lamella (2.1), the acting lever (11.3) of the micro-switch (11) naturally occupies its free position.

### 5. BRIEF DESCRIPTION OF THE DRAWINGS

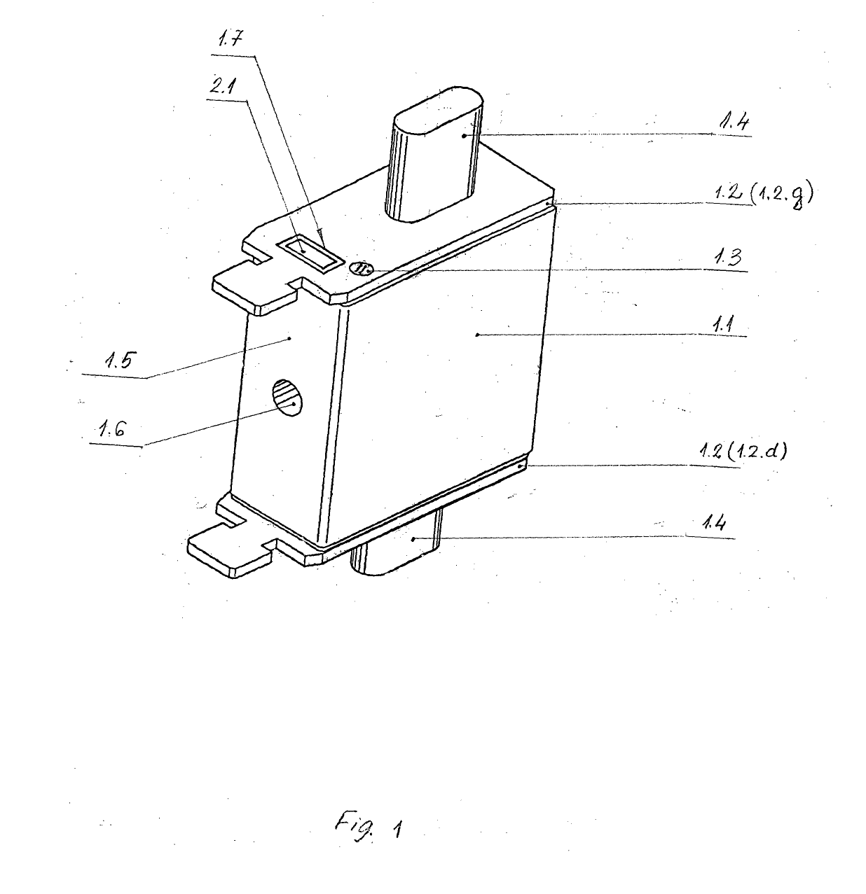

FIG. 1: External appearance of the cartridge for low-voltage high-power fuse, lateral view
Position 1.1: Housing mantle of the fuse link;
Position 1.2.: Cover of the fuse housing, upper (1.2g) and lower (1.2d);
Position 1.3.: Mounting screw;
Position 1.4.: Blades;
Position 1.5.: Frontal wall of the fuse housing;
Position 1.6.: Indicator opening in the wall of fuse housing;
Position 1.7.: Opening in the cover of fuse housing for indicator lamella;

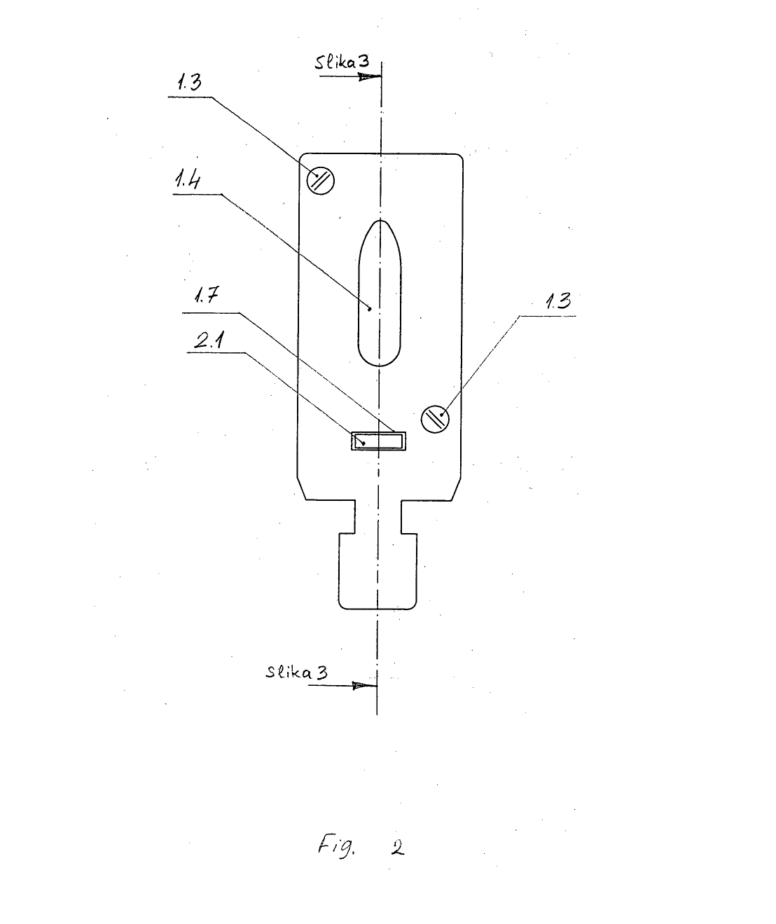

FIG. 2: Fuse cartridge, frontal view
Position 2.1.: Indicator lamella;

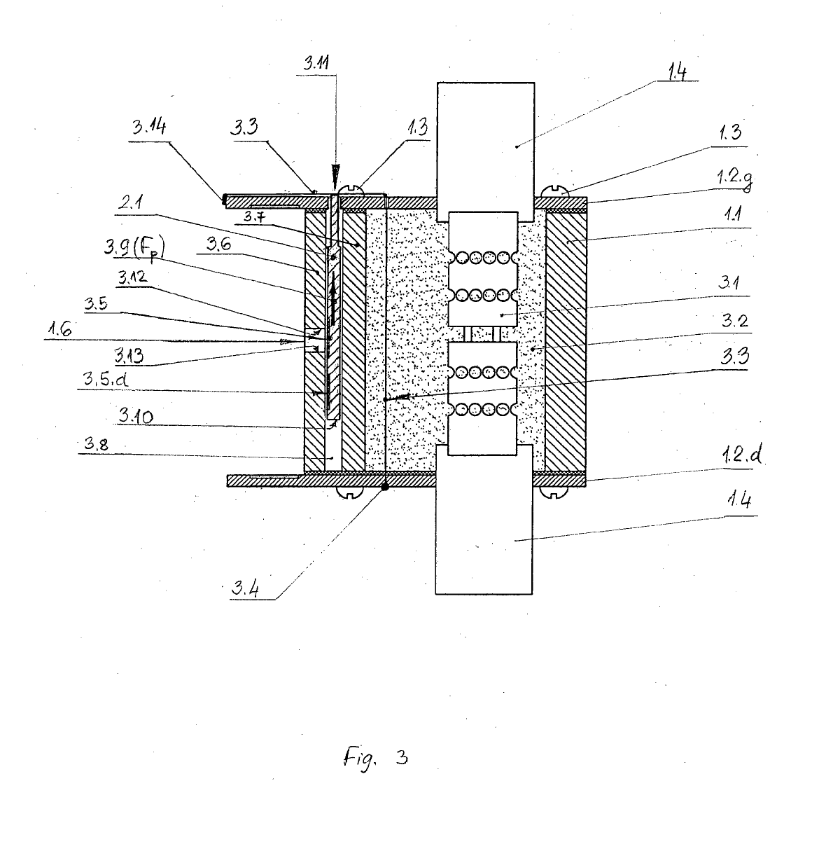

FIG. 3: Fuse cartridge in the starting position of the indicator lamella, respectively when the fuse link is not blown; longitudinal cross section
Position 3.1: Fuse link of the fuse;
Position 3.2: Silica sand in the fuse;
Position 3.3: Indicating melting wire;
Position 3.4: Lower connection of the indicating melting wire and lower cover of the fuse housing;
Position 3.5: Marking on the indicator lamella;
Position 3.5d: Additional marking on the indicator lamella;
Position 3.6: Frontal part of front wall of the fuse housing;
Position 3.7: Rear part of front wall of the fuse housing a;
Position 3.8: Channel of the indicator lamella;
Position 3.9: Displacement force F_{P}, acting on the indicator lamella;
Position 3.10: Lower front edge of the indicator lamella;
Position 3.11: Upper front edge of the indicator lamella;
Position 3.12: Upper edge of the indicator opening in the fuse mantle wall;
Position 3.13: Lower edge of the indicator opening in the fuse mantle wall;
Position 3.14: Upper connection of the indicating melting wire and upper cover of the fuse housing;

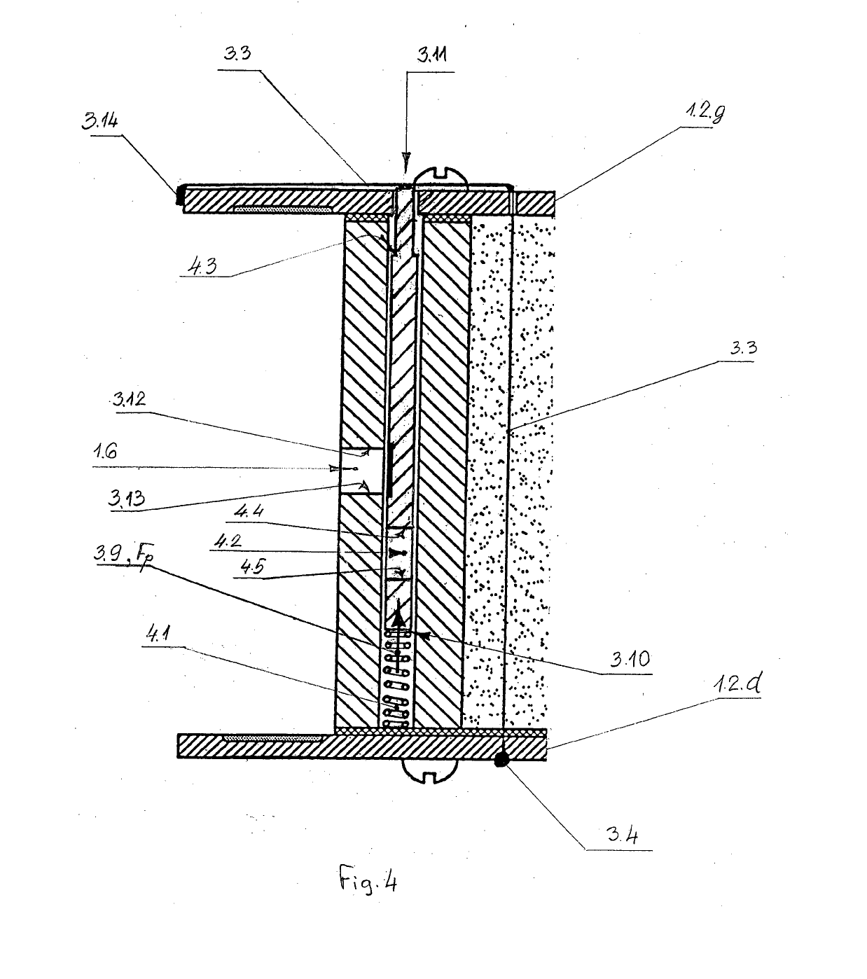

FIG. 4: Placement of the compressive spring and the indicator lamella according to the invention, inserted into the channel in its starting position, respectively when the fuse link of the fuse is not blown
Position 4.1: Compressive spring;
Position 4.2: Breach in the indicator lamella;
Position 4.3: Displacement limiter of the indicator lamella;
Position 4.4: Upper brim of the breach in the indicator lamella;
Position 4.5: Lower brim of the breach in the indicator lamella;

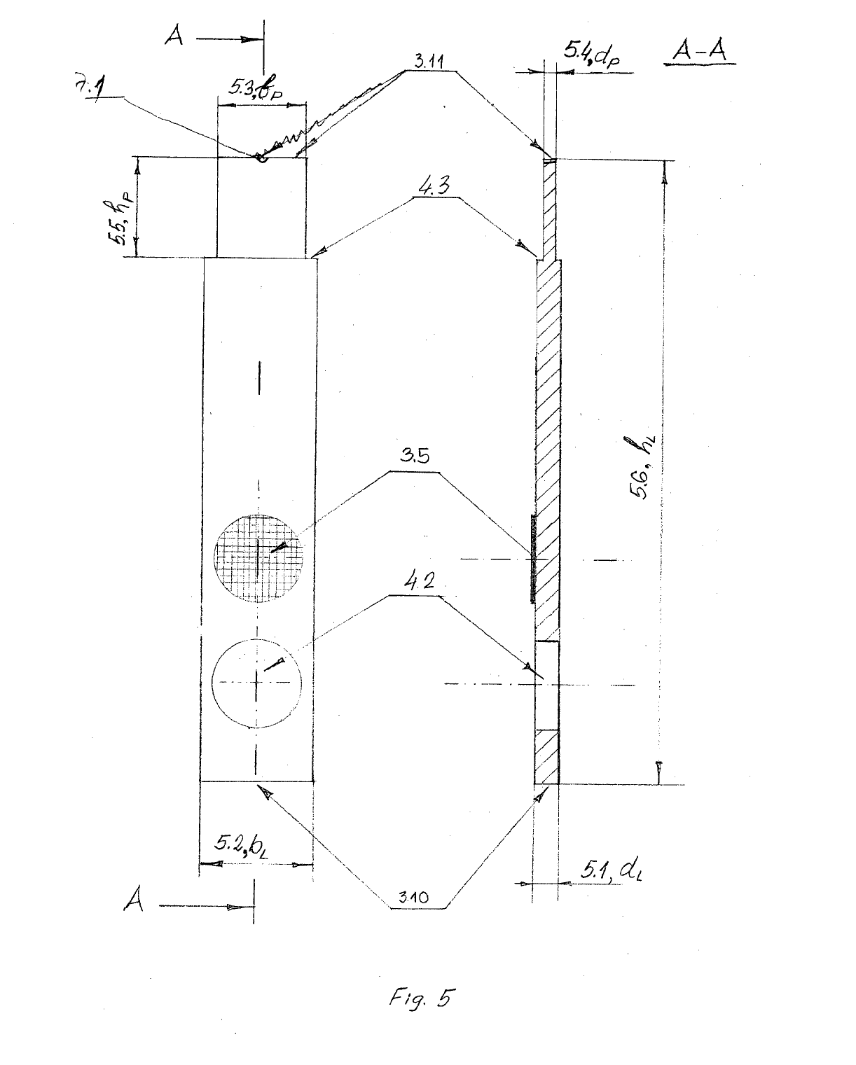

FIG. 5: Indicator lamella
Position 5.1: Thickness of the indicator lamella, d_{L};
Position 5.2: Width of the indicator lamella, b_{L};
Position 5.3: Reduced width of narrowed part of the indicator lamella, passing through the fuse housing cover, b_{P};
Position 5.4: Reduced thickness of narrowed part of the indicator lamella, passing through the fuse housing cover, d_{P}
Position 5.5: Reduced height of narrowed part of the indicator lamella, passing through the fuse housing cover, h_{P}
Position 5.6: Length of the indicator lamella, h_{L};

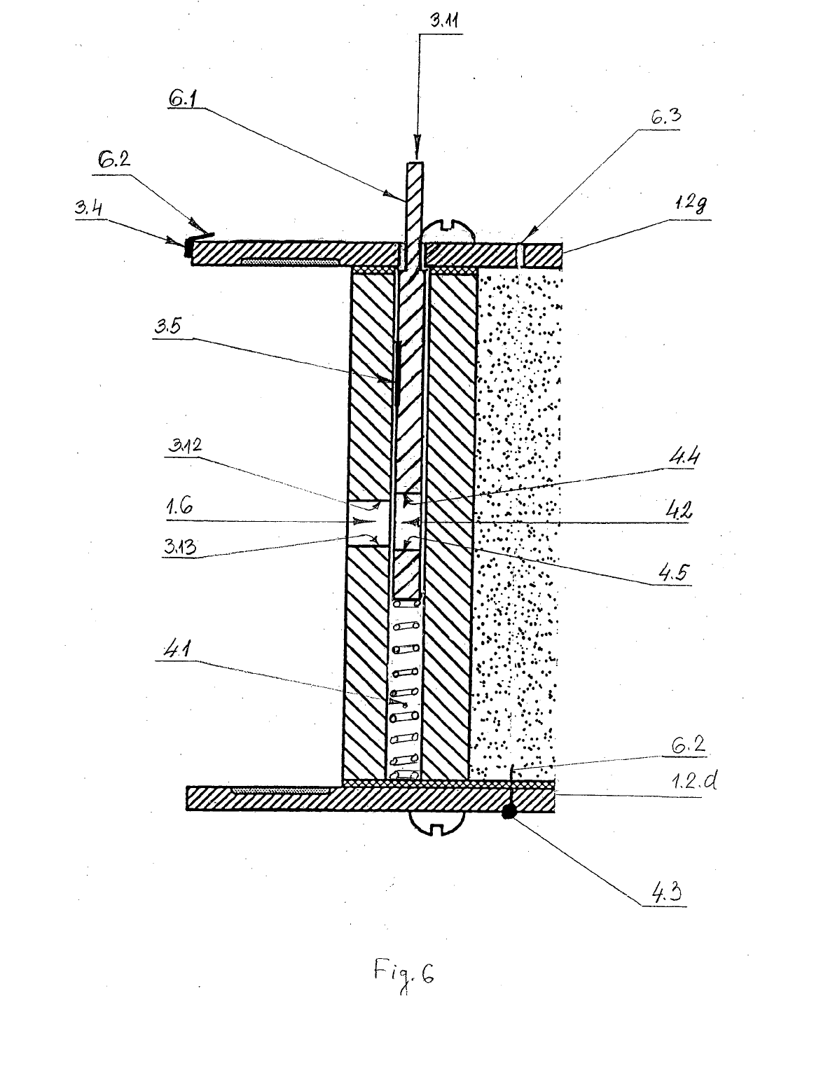

FIG. 6: Indicator lamella according to the invention inserted into channel in its final position, respectively when the fuse link of the fuse is blown
Position 6.1: Surface of the visible part of the indicator lamella;
Position 6.2: Remains of blown indicating melting wire;
Position 6.3: Bore in the cover of the fuse for indicating melting wire;

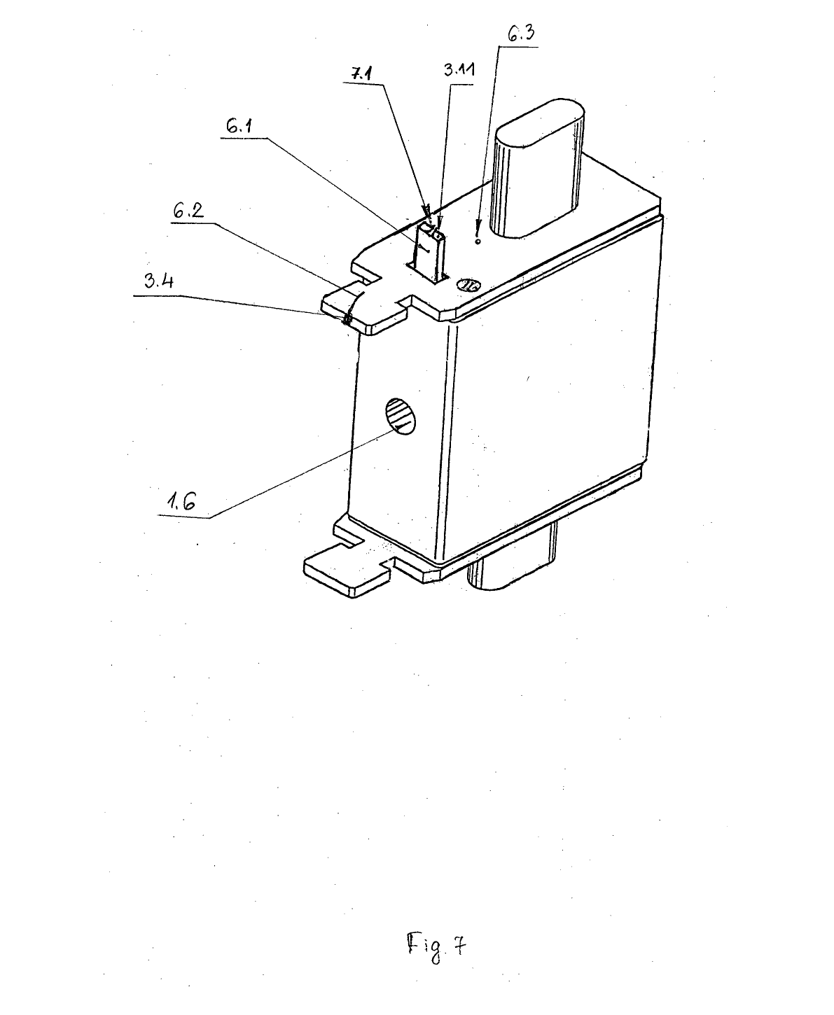

FIG. 7: Visible part of the indicator lamella, in its final position when the fuse link is blown
Position 7.1: Placement of the melting wire on the front edge of the indicator lamella;

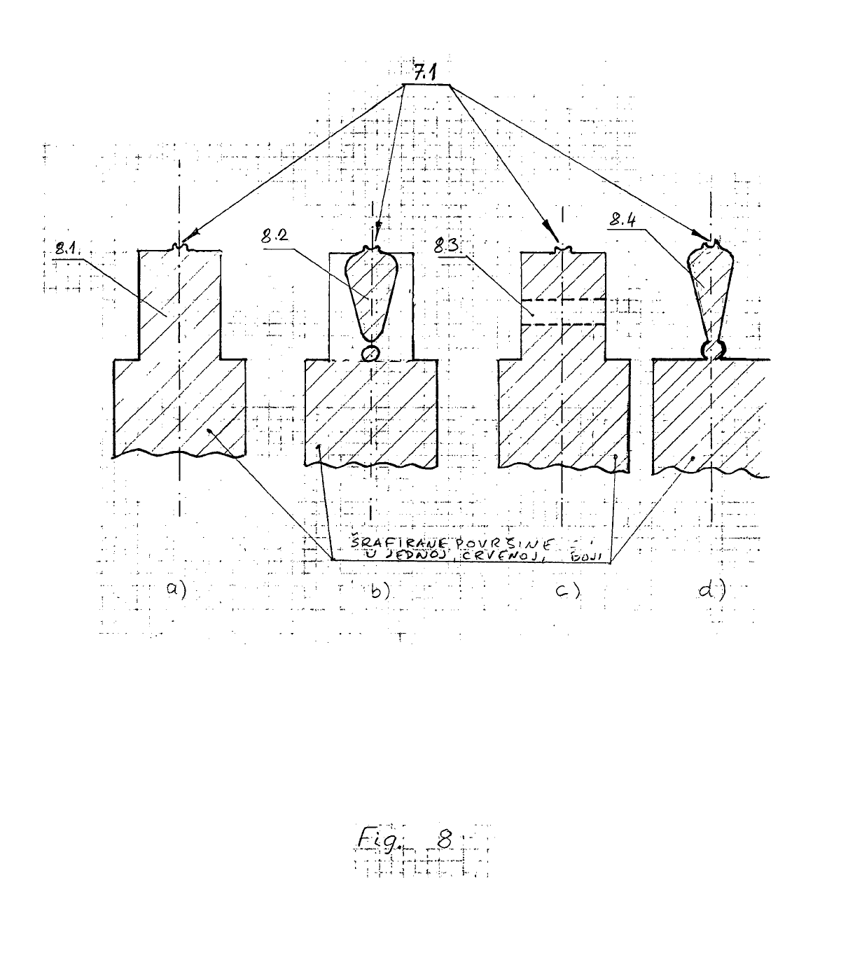

FIG. 8: Possible surface shapes of the indicator lamella visible parts
Position 8.1: Square surface shape of the visible part (6.1) on the indicator lamella (2.1) in a certain color;
Position 8.2: Marking shaped as an exclamation mark on the square surface of the visible part (6.1) on the indicator lamella (2.1) in a certain color;
Position 8.3: Spaced square forms on the square surface of the visible part (6.1) on the indicator lamella (2.1) in a certain color;
Position 8.4: Surface shaped as an exclamation mark of the visible part (6.1) of the indicator lamella (2.1) in a certain color;

FIG. 9: Possible shapes of the compressive springs
Position 9.1: Cylindrical shape of the compressive spring;
Position 9.2: Elliptic shape of the compressive spring;
Position 9.3: Laminated shape of the compressive spring;

FIG. 10: Possible joints of the compressive spring and indicator lamella
Position 10.1: Inner dimension d_{OS} of the compressive spring in its free state;
Position 10.2: Reduced dimension d_{OM} of the indicator lamella segment which is pulled on the part of the compressive spring;

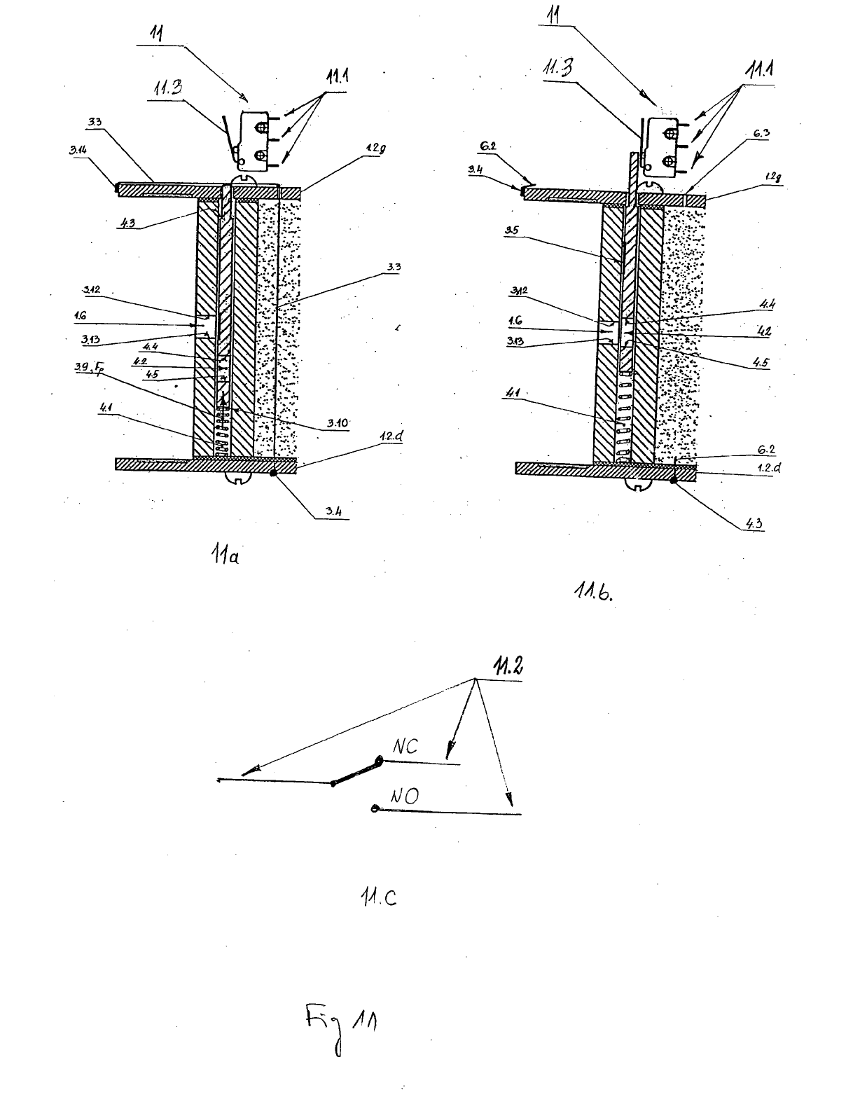

FIG. 11: Electrical contact for signaling of fuse link being blown/not blown
Position 11: Microswitch
Position 11a: Position of the indicator lamella and acting lever of the microswitch when the fuse link of the fuse is not blown;
Position 11b: Position of the indicator lamella and acting lever of the microswitch when the fuse link of the fuse is blown;
Position 11c.: Electric circuit of possible microswitch contacts arrangement;
Position 11.1: Microswitch connections;
Position 11.2: Electric connections in possible arrangement of the microswitch contact assembly

### 6. MODE FOR CARRYING OUT OF THE INVENTION

The technical solution for the status indicator for fuse link in fuses according to the invention is applied in the manufacturing of low-voltage high-power fuses, into whom it is built in as one of the integral subassemblies what is, in the solutions according to the known prior art, practice at least since 50-ies of the last century, when are dated the first attempts to register patents on the solutions (U.S. Pat. No. 2,797,279). Technology used in the manufacturing according to the technical solution belongs to the classic technologies and has not been substantially changed in the past period.

Related to the common ones, the realization of low-voltage high-power fuses into which is built in the assembly technically solved according to the invention, the status indicator for fuse link of fuse cartridge requests a channel (3.8) to be made in the housing mantel (1.1) of the fuse, as a rule in its front side in axial direction, into which the indicator lamella (2.1) is inserted and into whom takes place its translational motion form the starting to the final position. The housing mantle (1.1) of the fuse is made of appropriate isolation material, ceramics or steatite or similar, what is realized according to the technology actually regarded as classical solutions.

As in the solutions according to the known state of the art comprised in some previously quoted patent documents, which anticipate the channel (3.8) of the indicator lamella to be realized only in one part of the total height of the housing mantle (1.1) of the fuse, the technical solution according to the invention primarily comprises the realization of the channel (3.8) of the indictor lamella in the entire height of the housing mantle (1.1) of the fuse, what is beneficial in manufacturing of the housing mantle (1.1).

Otherwise, the dimensions of the indicator lamella (2.1) according to the invention are such that its length (5.6) multiply larger than its thickness, and may be produced of any material appropriate in shape and cross section. An optimal solution according the invention concerned is production of the indicator lamella (2.1) in thermoplastic material injection technology. As a further and particular advantage regarding economy there is a possibility to make the indicator lamella (2.1) of the appropriate material in color that is to be visible in the starting position through the indicator opening (1.6) in the fuse mantle wall, at the same time corresponding to the surface color (6.1) of the visible part of the indicator lamella (2.1) in its final position, what in both cases excludes the necessity to apply colors to the respective parts of the indicator lamella (2.1) surface.

One or more compressive springs (4.1) present as a rule a classic spring of appropriate shape and dimensions regarding its placing in the channel (3.8) of the indicator lamella, thereby to ensure obtaining of necessary force F_{P} (3.9) for displacing of the indicator lamella along the channel (3.8) of the indicator lamella. The technical solution according to the invention enables placing of one or more compressive springs (4.1) of requested dimensions and characteristics into the channel (3.8) of the indicator lamella without its widening in any part, what makes advantage in comparison to alternative solutions comprised by the known prior art.

The compressive spring that produces the force F_{P} (3.9) for displacing of the indicator lamella along the channel (3.8) of the indicator lamella may have any of the known forms of the compressive springs, as elliptic, cylindrical and laminated ones. Its design may be adapted to enable its firm connection to the indicator lamella (2.1) using some of the methods depicted in the FIG. 10 and forming the subassembly of the indicator lamella which is as an entity in the course of assemblage inserted into the channel (3.8) of the indicator lamella.

Indicating melting wire (3.3), mechanically and electrically firmly connected to the covers (1.2) of the fuse housing, upper (1.2g) and lower (1.2d) one, is placed into the fuse cartridge housing in such way that it is electrically connected in parallel to the fuse link (3.1) of the fuse and it is firmly tensed and laid above the upper front edge (3.11) of the indicator lamella; in such way the displacement of the indicator lamella (2.1) is protected, in spite of the action of force F_{P} (3.9) ensured by one or more compressive springs for displacement of the indicator lamella along the channel (3.8), until the moment when occurs blow of the fuse link (3.1) of the fuse and therefore also blow of the indicating melting wire (3.3).

### 7. APPROACH TO THE INDUSTRIAL APPLICATION OF THE INVENTION

The invention concerned finds its industrial application within the area of manufacturing and exploiting the low-voltage high-power fuses, into which is built in an additional assembly of a combined indicator for determining the state of fuse link of the fuse.

The course of industrial application of the invention is obvious already from the description of the invention nature itself what is additionally explained in the described way of its implementation. The industrial application of the invention, apart from not being doubtful, particularly points that the technical solution according to the invention presents better, more reliable and more efficient alternative solution compared to the already existing solutions being comprised in the known state of the art or are globally used in the production of low-voltage high-power fuses.

In the industrial applications of the invention to the full expression are coming simple forms of the indicator lamella assembly parts, representing the decisive advantage in its manufacturing, with the use of thermoplastic material injection technologies, as well as in compressive spring in high series which are ordinary at low-voltage high-power fuses.

Simple connecting of the indicator lamella (2.1) and the compressive spring (4.1) realizes a unique assembly whose inserting into the fuse cartridge is exceptionally easy and simple so that the automation of the procedure is possible.

The further advantage of the technical solution for the indicator comprises in the fact that the applying of the substantial idea of the invention is also possible for all fuse cartridge sizes.

1. Fuse link status indicator for a low-voltage high-power fuse, whose desired characteristic of activation is realized using the fuse link of the adequate shape, made of, as a rule, a copper strip of appropriate thickness and shape, the fuse links being placed in silica sand (3.2) inside the space of the housing mantle of the fuse (1.1), whose cross section shape may be, by choice, square (rectangle, quadrate) or round to oval in shape, and on both of whose sides the are, using screws (1.3), fixed covers (1.2) of the fuse housing, through which pass connecting elements (1.4), wherewith a closed space is created inside which, out of environmental influences, the fuse link acts (3.1) of the fuse as well as the indicating melting wire (3.3), whereat the assembly of the indicator for the fuse links cartridge of low-voltage high-power fuse comprises of an adequately shaped movable part which is located in the channel (3.8) for the indicator lamella, which is made in the housing mantle wall (1.1) of the fuse, so that the movable part of the indicator assembly moves between the two outermost, starting and final positions, and to which in a specific way the created force acts in the direction of displacing the movable part from the starting to the final position, whose shifting is physically prevented by the indicating melting wire (3.3), fixed to the fuse housing covers, lower (1.2d) and upper (1.2g) one, and at the same time is tense in front of the upper front edge(3.11) of the movable part and electrically connected in parallel to the fuse link (3.1) of the fuse, this state lasting till the occurrence of the blowing out of the fuse link (3.1) of the fuse and thereby the indicating melting wire (3.3) itself, and hereby the physical obstacle to move the movable part into its final position disappears, which is characterized by the compressive spring (4.1) located in the lower part of the channel (3.8) of the indicator lamella (2.1), pressing with one of its ends leaned against the lower cover (1.2d) of the fuse housing and with its other end leaning against the lower front edge (3.10) of the indicator lamella (2.1), thereby, acting on it with the required displacement force F_{P} (3.9), tending to move the indicator lamella (1.2) from the starting to the final position, its length being h_{L}, shaped so that its lower front edge (3.10), against which the compressive spring (4.1) is leaning with one of its ends, always, hence, both in the starting and also in the final position, finds itself below the lower edge (3.13) of the indicator opening (1.6) in the frontal part of the front wall (3.6) of the housing/mantle (1.1) of the fuse, whereat the indicator lamella (2.1) is designed so that at the appropriate place through its whole thickness d_{L} (5.1) a breach (4.2) is made, which is, relatively to the shape, size and location of the indicator opening (1.6) in the frontal part of the front wall (3.6) of the housing/mantle (1.1) of the fuse, of such shape and size and so located on the indicator lamella (2.1), that in the final position of the indicator lamella (2.1) such coincidence of the breach (4.2) and the indicator opening is obtained (1.6), so that, through the indicator opening (1.6) in the fuse mantel wall, not a single part of the indicator lamella surface be visible (2.1), nor any part of the compressive spring (4.1);

2. Fuse link status indicator for a low-voltage high-power fuse, according to patent claim 1, is characterized by the indicator lamella (2.1) being completely made of any one, primary thermoplastic material of a chosen colour in injection technology or by the whole indicator lamella (2.1) being made of any one material and then entirely painted in the chosen colour, whose chosen colour in both cases may be identical, but also different from the colour of the marking (3.5) which has to be visible through the indicator opening (1.6) in the fuse housing wall when the indicator lamella (2.1) is in the starting position,

3. Fuse link status indicator for a low-voltage high-power fuse, according to patent claims 1 and 2, is characterized by the surface (6.1), as an integral part of the indicator lamella (2.1) next to its upper front edge (3.11), in the final position of the indicator lamella (2.1) protruding above the upper cover (1.2g) of the fuse housing which, along with the marking (3.5) of the appropriate colour which in this final position of the indicator lamella (2.1) being visible or invisible through the indicator opening (1.6) in the fuse housing wall, representing an additional indication on whether the fuse link (3.1) of the fuse is blown.

4. Fuse link status indicator for a low-voltage high-power fuse, according to patent claim 3, is characterized by the surface (6.1), of the visible part of the indicator lamella (2.1) in its final position being designed in the shape of a square or rectangle (8.1), exclamation mark (8.4) or adequate symbol that is commonly used for marking the states of electric short circuit (8.3) or that the desired symbol is glued to this surface or is paint on, as for instance the exclamation mark (8.4) or some of symbols quoted above;

5. Fuse link status indicator for a low-voltage high-power fuse, according to patent claims 1 and 2, is characterized by the indicator lamella (2.1), without a breach (4.2) being made, but of such length h_{L} and shaped so that in its final position its lower front edge (3.10), which is pressed against one end of the compressive spring (4.1) occupies the position below the lower edge (3.13) of the indicator opening (1.6), and on the indicator lamella (2.1) one, two or all the three markings are posted (3.5), (3.5d) and (6.1) by painting a layer of desired colour in the adequate shape, so that through the indicator opening (1.6) on the frontal part of the front wall (3.6) of the fuse housing/mantel (1.1) one marking (3.5) is visible in the starting, and the second (3.5d) in the final position of the indicator lamella (2.1) simultaneously with the marking (6.1);

6. Fuse link status indicator for a low-voltage high-power fuse, according to patent claims 1, 2, 3, 4 and 5, is characterized by the compressive spring (4.1) being designed in one of the shapes as are: round (9.1), elliptic (9.2) or laminated (9.3);

7. Fuse link status indicator for a low-voltage high-power fuse, according to patent claim 6, is characterized by there being between the compressive spring (4.1) and the indicator lamella (2.1) a reliable, lasting and firm connection, which is achieved in the manner that the compressive spring (4.1) with its inner dimension d_{OS} (10.1) in its free state is pulled on the part of the indicator lamella (2.1) with the reduced dimension d_{OM} (10.2), in which the inner dimension d_{OS} (10.1) of the compressive spring (4.1) is for a certain measure smaller than the reduced dimension d_{OM} (10.2) of the indicator lamella (2.1);

8. Fuse link status indicator for a low-voltage high-power fuse, which also includes a microswitch to enable electric signalling of the indicator lamella position, respectively weather the fuse link of the fuse is blown or not is characterized by the microswitch (10) being located on and properly fixed to the upper cover (1.2g) of the fuse housing, so that on its acting lever (11.3) with the two possible outer, free and compressed position, the indicator lamella acts (2.1) during the motion from the starting position, when the acting lever (11.3) of the microswitch (11) naturally occupies the free position, and the indicator lamella (2.1) achieving its final position acts to the pertaining acting lever (11.3) of the microswitch (11), as a result, the indicator lamella (2.1) shifts the acting lever (11.3) of the microswitch (11) from its free to the compressed position which is followed by the switching of the selected contact circuit of the microswitch (11) with the corresponding connectors (11.1) of NO and NC contacts (11.2).
